(19) United States
(12) Patent Application Publication
(10) Pub. No.: US 2024/0270459 A1
(43) Pub. Date: Aug. 15, 2024

(54) Painting Supplies Storage Device And Method Of Use

(71) Applicant: Lawrence Ozobu, Indianapolis, IN (US)

(72) Inventor: Lawrence Ozobu, Indianapolis, IN (US)

(21) Appl. No.: 18/110,188

(22) Filed: Feb. 15, 2023

(51) Int. Cl. B65D 51/32; B01F 27/112; B01F 27/191; B01F 27/90; B01F 33/501; B01F 35/32; B01F 35/50; B44D 3/08; B44D 3/12; B65D 25/20; B65D 25/28; B65D 43/02; B65D 43/06; B65D 53/02; B65D 85/00; H01M 10/42; H01M 10/44; H01M 10/46

(52) U.S. Cl. CPC B65D 51/32; B01F 27/112; B01F 27/191; B01F 27/90; B01F 33/5014; B01F 35/32025; B01F 35/54; B44D 3/08; B44D 3/127; B65D 25/20; B65D 25/2867; B65D 43/0202; B65D 43/06; B65D 53/02; B65D 85/70; H01M 10/425; H01M 10/44; H01M 10/465; B01F 2101/30; B65D 2251/205; B65D 2525/281; B65D 2543/00092; B65D 2543/00972; H01M 2220/30

(57) ABSTRACT

A painting supplies storage device that prevents drying and settling of paint includes a container, which has an open top for addition of an open can of paint. A lid is selectively attachable to the container to sealably close the open top. A hole is axially positioned in the lid. A first rod is positioned through the hole and is rotationally and sealably attached to the lid. A lower end of the first rod is positioned proximate to a bottom of the container and its upper end protrudes from the lid. A plurality of paddles is attached to and extends from the first rod. A rotator assembly is attached to the upper end of the first rod to selectively rotate the first rod, whereby the paddles mix the paint. A shell, an upper facet of which is open, is attached to the container for stowage of one or more painting tools.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage devices and more particularly pertains to a new storage device that prevents drying and settling of paint. The present invention discloses a container, to which a lid is sealably attachable, and a rotator assembly for mixing paint in the container.

### (2) Description of Related Art Including Information Disclosed Under 37 CFR 1.97 and 1.98

The prior art relates to storage devices, which may comprise containers for painting tools, containers that hold a paint can, trays for holding multiple paint cans. Related prior art comprises cases for storing a plurality of small paint containers or a plurality of paint brushes. What is lacking in the prior art is a storage device comprising a container for holding an open can of paint that is sealably closable with a lid and including a rod, extending through the lid, to which paddles are attached for mixing the paint. Further lacking in the prior art is such a container having a shell attached, wherein painting supplies are stowable in the shell.

### BRIEF SUMMARY OF THE INVENTION

An embodiment of the disclosure meets the needs presented above by generally comprising a container, which has an open top so that the container is configured for addition of an open can of paint. A lid is selectively attachable to the container to sealably close the open top. A hole is axially positioned in the lid. A first rod is positioned through the hole and is rotationally and sealably attached to the lid. A lower end of the first rod is positioned proximate to a bottom of the container and an upper end of the first rod protrudes from the lid. A plurality of paddles is attached to and extends from the first rod. A rotator assembly is attached to the upper end of the first rod and is configured to selectively rotate the first rod, whereby the paddles are configured to mix the paint. A shell, an upper facet of which is open, is attached to the container and extends from proximate to the bottom to proximate to the open top of the container. The shell is configured to stow one or more painting tools.

An embodiment of the disclosure included a method of storing painting supplies, which comprises a first and second provision steps that entails providing paint and one or more painting tools and providing a painting supplies storage device, according to the disclosure above, respectively. Operational steps of the method are adding the open can of paint to the container, attaching the lid to the container, inserting the one or more painting tools into the shell, and selectively rotating the first rod to mix the paint.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a painting supplies storage device according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is a side view of an embodiment of the disclosure.

FIG. 6 is an end view of an embodiment of the disclosure.

FIG. 7 is an isometric perspective view of an embodiment of the disclosure.

FIG. 8 is an in-use view of an embodiment of the disclosure.

FIG. 9 is a detail view of an embodiment of the disclosure.

FIG. 10 is a detail view of an embodiment of the disclosure.

FIG. 11 is a flow diagram for a method utilizing an embodiment of the disclosure.

### DETAILED DESCRIPTION OF THE INVENTION

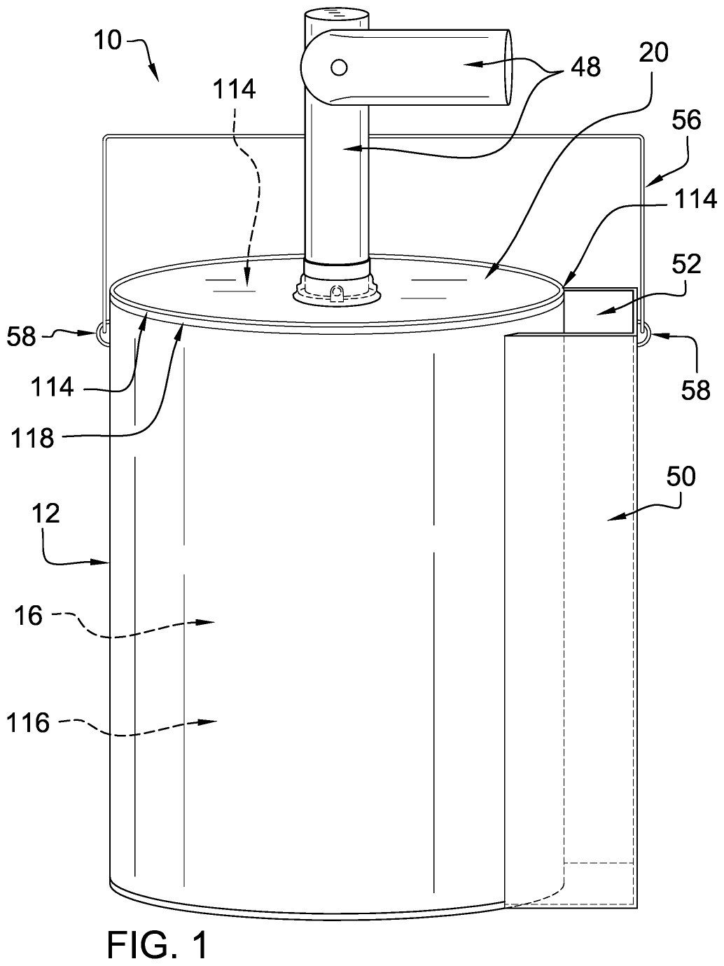

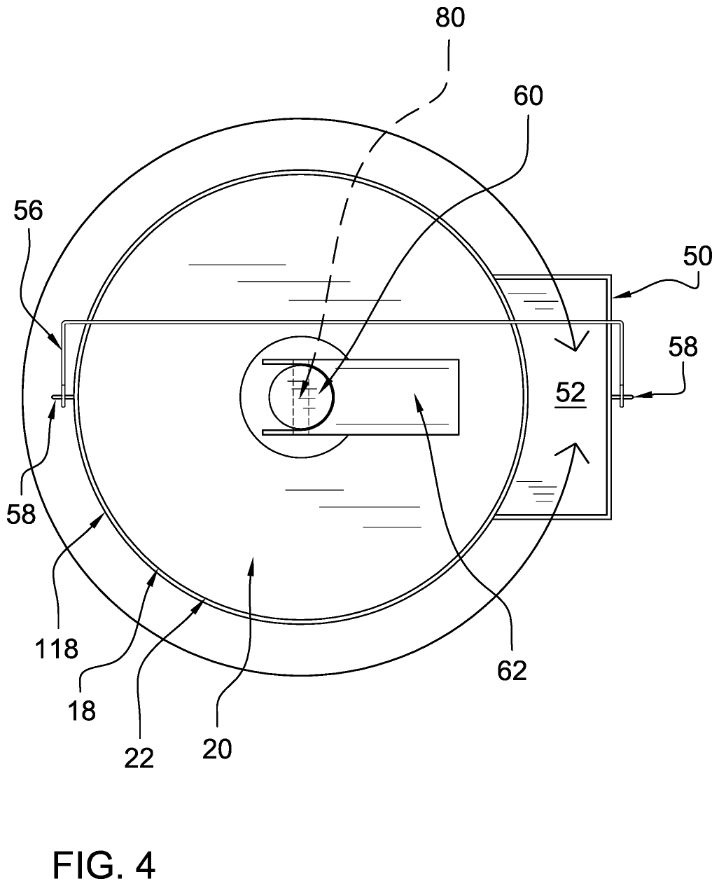

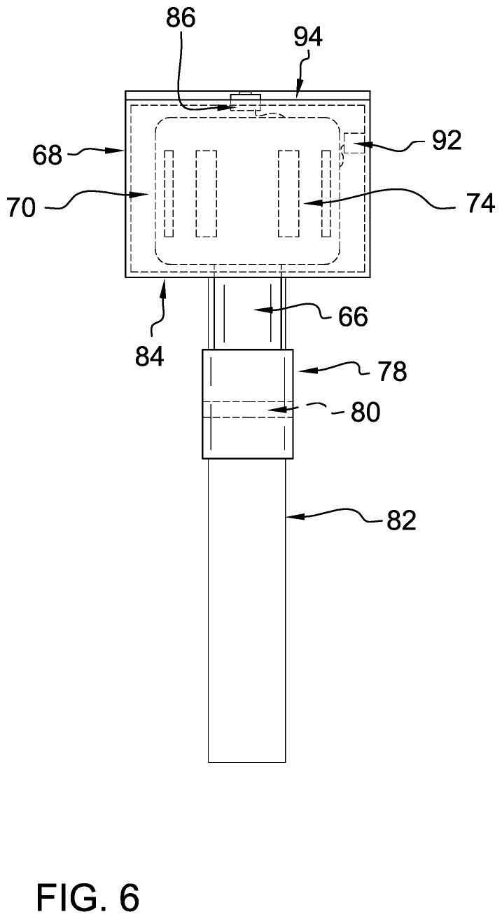

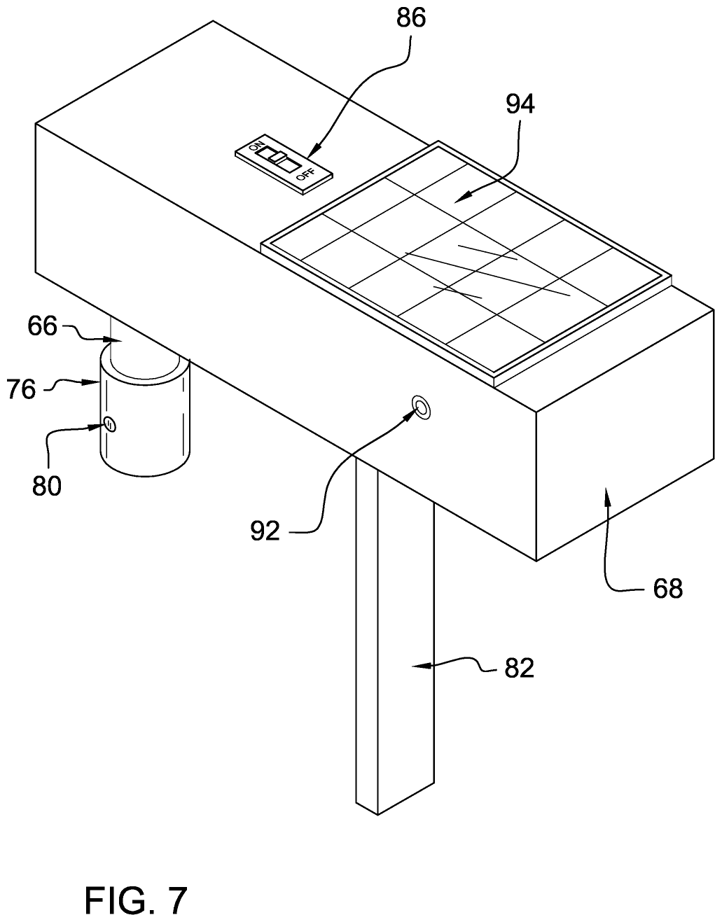

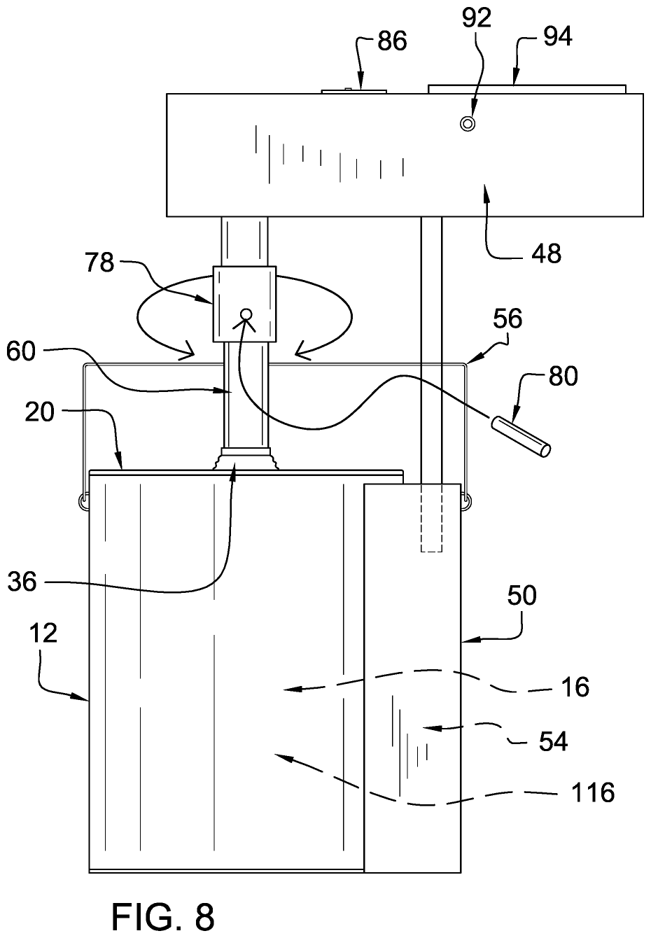

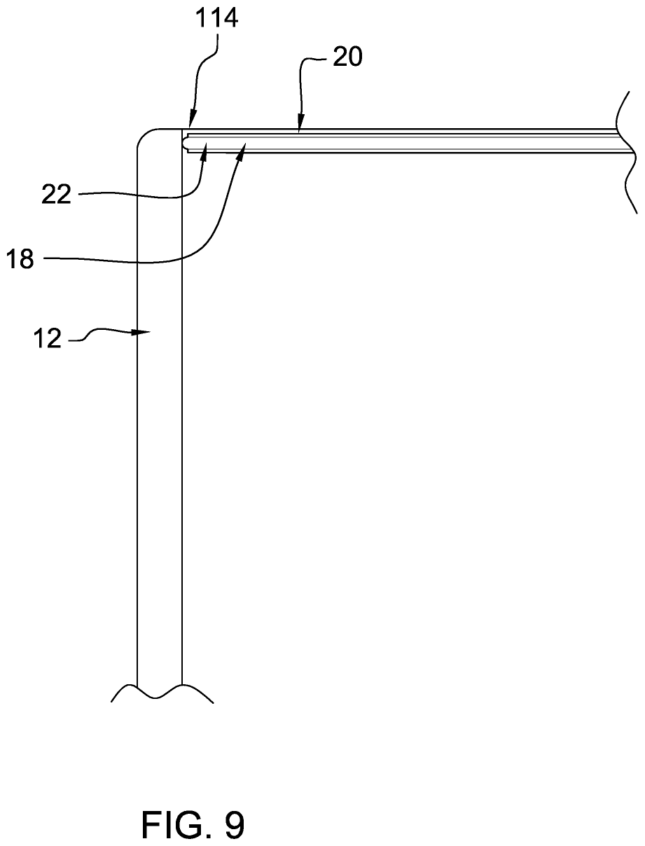

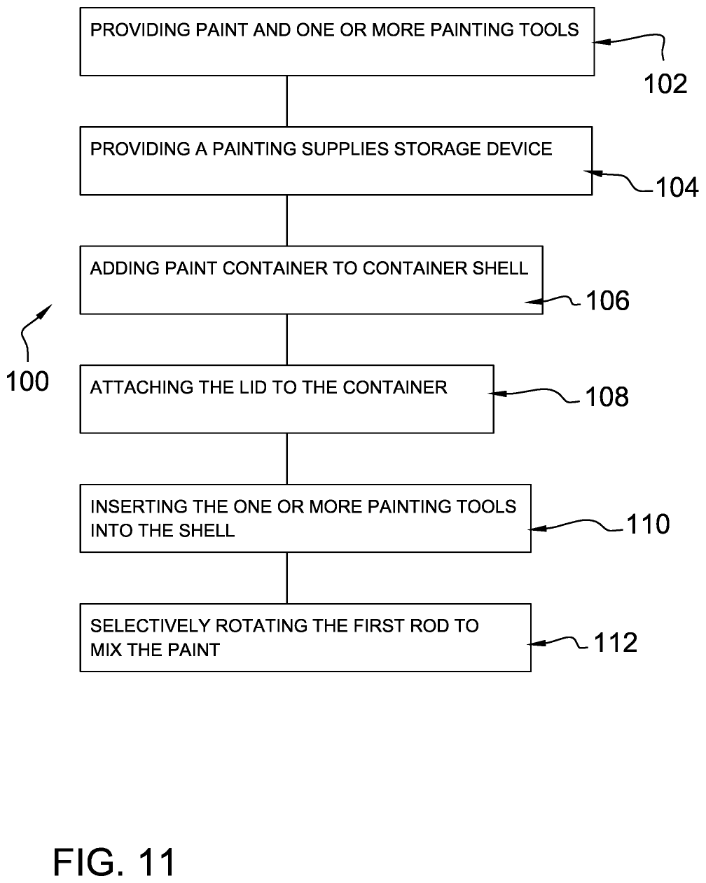

With reference now to the drawings, and in particular to FIGS. 1 through 11 thereof, a new storage device embodying the principles and concepts of an embodiment of the disclosure and generally designated by the reference numeral 10 will be described.

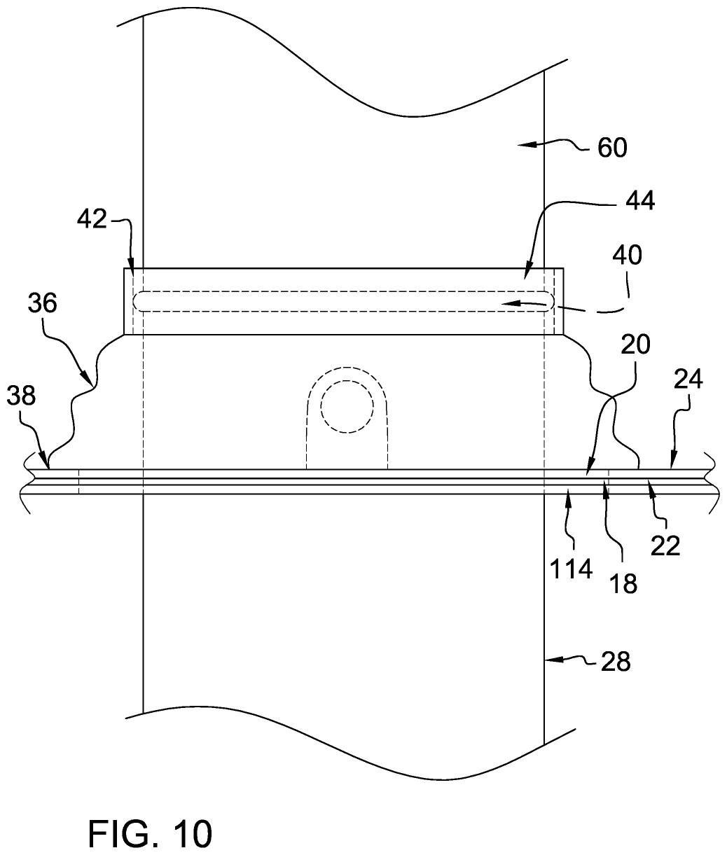

As best illustrated in FIGS. 1 through 11, the painting supplies storage device 10 generally comprises a container 12, which is cylindrical and which has an open top 14 so that the container 12 is configured for addition of an open can 116 of paint 16. A rim 114 is attached to the container 12 and extends circumferentially around the open top 14. A channel 18 extends into and circumferentially around the rim 114. A lid 20 is selectively attachable to the container 12 to sealably close the open top 14. As shown in FIG. 10, a gasket 22 is attached to the lid 20 and extends circumferentially around the lid 20 proximate to a perimeter 24 of the lid 20. The gasket 22 is selectively insertable into the channel 18 to sealably attach the lid 20 to the container 12.

A hole 26 is axially positioned in the lid 20. A first rod 28 is positioned through the hole 26 and is rotationally and sealably attached to the lid 20. A lower end 30 of the first rod 28 is positioned proximate to a bottom 32 of the container 12 and an upper end 34 of the first rod 28 protrudes from the lid 20. As shown in FIG. 10, a pleated tube 36 is attached by its lower limit 38 to the lid 20 and extends circumferentially around the hole 26. The pleated tube 36 is elastomeric and conically frustum shaped. An O-ring 40 is attached to the pleated tube 36 proximate to its upper limit 42. A collar 44 is positioned around the pleated tube 36 proximate to the upper limit 42 so that the O-ring 40 is compressed between the collar 44 and the first rod 28. The pleated tube 36 and the O-ring 40 thus are configured to prevent passage of gas through the hole 26.

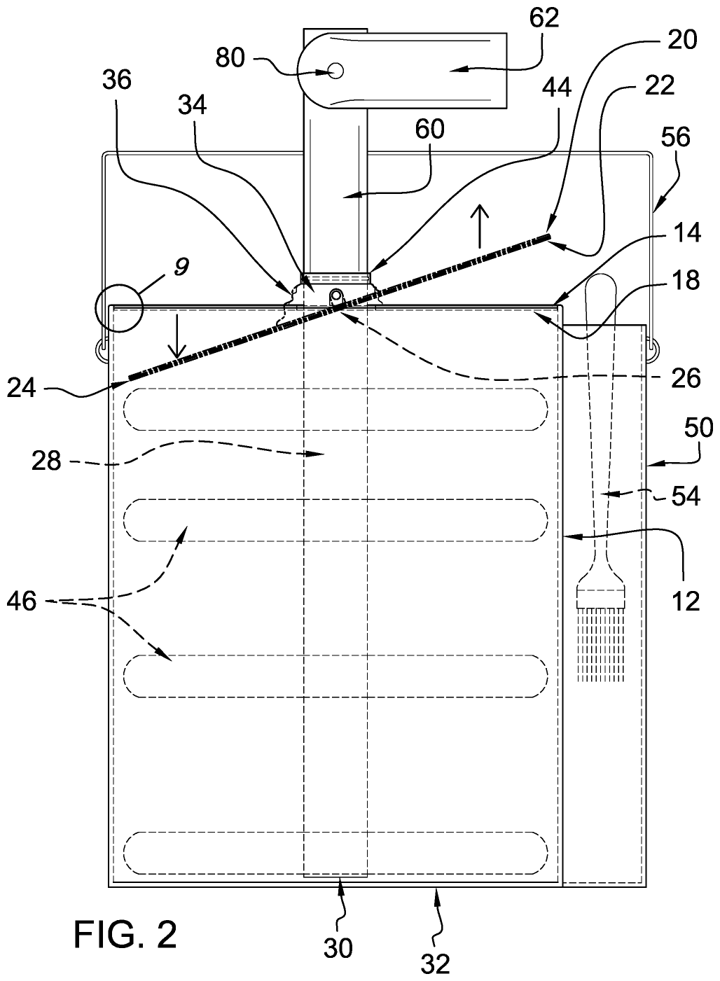

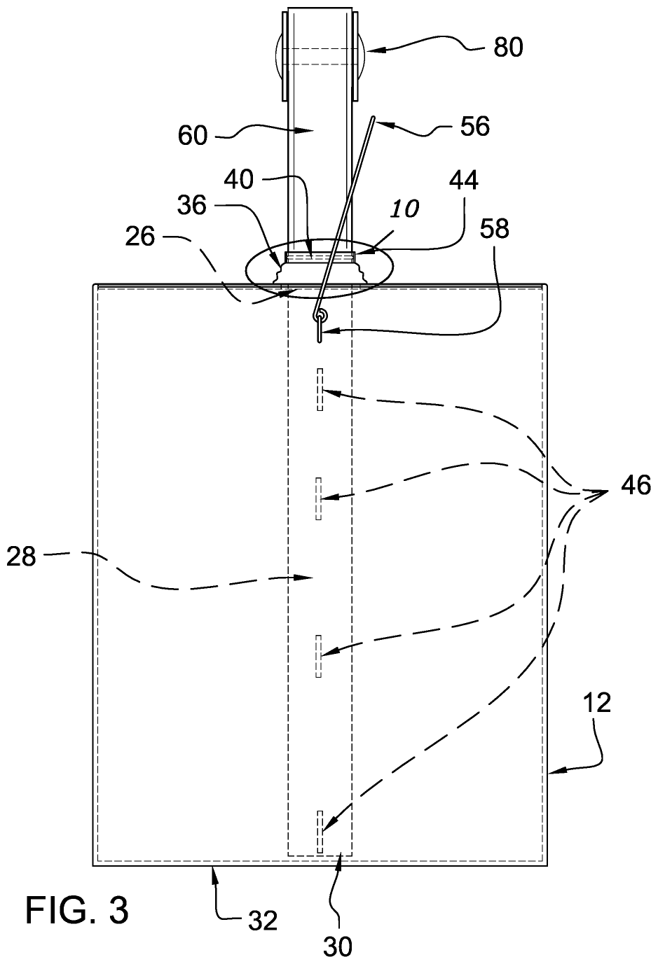

A plurality of paddles 46 is attached to and extends from the first rod 28. As shown in FIGS. 2 and 3, a rotator assembly 48 is attached to the upper end 34 of the first rod 28 and is configured to selectively rotate the first rod 28, whereby the paddles 46 are configured to mix the paint 16.

A shell 50, which is substantially cuboid and which has an upper facet 52 that is open, is attached to the container 12 and extends from proximate to the bottom 32 to proximate to the open top 14 of the container 12. The shell 50 is configured to stow one or more painting tools 54.

A handle 56 is pivotally attached to the container 12 or to both of the container 12 and the shell 50. The handle 56 is configured to be grasped in a hand of a user, positioning the user to lift the container 12 and the shell 50. As shown in FIG. 2, the handle 56 is attached to and extends between the rings 58 of a pair of rings 58. One ring 58 is attached to the container 12 and the other ring 58 is attached to the shell 50.

The rotator assembly 48 comprises a second rod 60, which is pivotally attached to the upper end 34 of the first rod 28. The second rod 60 is selectively pivotable between a stowed configuration and a deployed configuration. In the stowed configuration, the second rod 60 is substantially parallel with the lid 20, whereas, in the deployed configuration, as shown in FIG. 2, the second rod 60 extends substantially linearly from the first rod 28.

The rotator assembly 48 may comprise a third rod 62, as shown in FIGS. 1-4, which is removably and pivotally attachable to the second rod 60 distally from the first rod 28. The third rod 62 is selectively pivotable between a stowed position and a deployed position. In the stowed position, the third rod 62 is substantially parallel with the second rod 60. In the deployed position, the third rod 62 extends substantially perpendicularly from the second rod 60, wherein the third rod 62 is configured to be grasped in a hand of a user, positioning the user to manually rotate the paddles 46 to mix the paint 16.

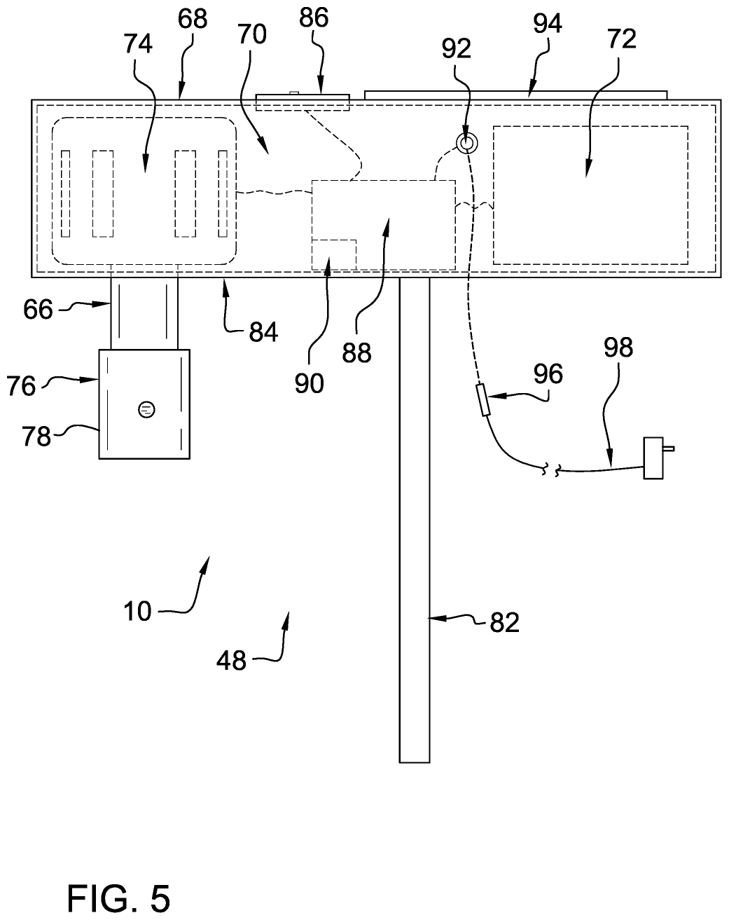

The rotator assembly 48 also may comprise a rotary tool 64, as shown in FIGS. 5-8, which has a drive shaft 66 that is configured to selectively engage the second rod 60 distal from the first rod 28. The rotary tool 64 is configured for selective actuation to rotate the paddles 46 to mix the paint 16. While a variety of rotating tools are anticipated by the present invention, the rotary tool 64 may be as depicted in FIGS. 5-10, wherein the rotary tool 64 comprises a housing 68 that defines an interior space 70.

A battery 72 and a motor 74 are attached to the housing 68 and are positioned in the interior space 70, with the drive shaft 66 of the motor 74 extending from the housing 68. A coupler 76 is attached to the drive shaft 66 distal from the housing 68 and is configured to selectively engage the second rod 60. The coupler 76 may comprise a sleeve 78 into which the second rod 60 is partially insertable, with the sleeve 78 being attached to the second rod 60 by a locking pin 80. The locking pin 80 also may be used to pivotally attach the third rod 62 to the second rod 60. The present invention anticipates the coupler 76 comprising other coupling means, such as, but not limited to, chucks, twist locks, and the like.

An arm 82 is attached to and extends from a lower facet 84 of the housing 68 distal from the drive shaft 66. The arm 82 is substantially parallel to the drive shaft 66 and is selectively insertable into the shell 50 as the rotary tool 64 is attached to the second rod 60. Thus positioned, the arm 82 prevents rotation of the rotary tool 64 relative to the container 12 as the paint 16 is being mixed.

A switch 86 is attached to the housing 68. A microprocessor 88 is attached to the housing 68, is positioned in the interior space 70, and is operationally engaged to the battery 72, the motor 74, and the switch 86. The switch 86 is configured to be selectively switched to signal the microprocessor 88 to actuate the motor 74 to mix the paint 16. A timer 90 is operationally engaged to the microprocessor 88 to enable a mixing schedule, for example, once or twice a week for fifteen minutes. Mixing the paint 16 on a routine schedule prevents the paint 16 from drying and settling.

The battery 72 may be rechargeable. A port 92 and a solar panel 94 are attached to the housing 68 and are operationally engaged to the microprocessor 88. The port 92 is configured to selectively couple to a plug 96 of a charging cord 98 to charge the battery 72. The solar panel 94 is configured to convert electromagnetic radiation to an electrical current to charge the battery 72.

In use, the painting supplies storage device 10 enables a method of storing painting supplies 100, which comprises a first provision step 102 that entails providing an open can 116 of paint 16 and one or more painting tools 54. A second provision step 104 of the method 100 is providing a painting supplies storage device 10, according to the specification above. A first operational step 106 of the method 100 is adding the open can 116 of the paint 16 into the container 12. A second operational step 108 of the method 100 is attaching the lid 20 to the container 12. A third operational step 110 of the method 100 is inserting the one or more painting tools 54 into the shell 50. A fourth operational step 112 of the method 100 selectively rotating the first rod 28 to mix the paint 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A painting supplies storage device comprising:
a container having an open top, wherein the container is configured for addition of an open can of paint through the open top;
a lid selectively attachable to the container for sealably closing the open top;
a hole axially positioned in the lid;
a first rod positioned through the hole such that a lower end of the first rod is positioned proximate to a bottom of the container and an upper end of the first rod protrudes from the lid, the first rod being rotationally and sealably attached to the lid;
a plurality of paddles attached to and extending from the first rod;
a rotator assembly attached to the upper end of the first rod and being configured for selectively rotating the first rod, wherein the paddles are configured for mixing the paint; and
a shell attached to the container and extending from proximate to the bottom to proximate to the open top of the container, an upper facet of the shell being open, wherein the shell is configured for stowage of one or more painting tools.

2. The painting supplies storage device of claim 1, wherein the container is cylindrical.

3. The painting supplies storage device of claim 1, further including:
a rim attached to the container and extending circumferentially around the open top;
a channel extending into and circumferentially around the rim; and
a gasket attached to the lid and extending circumferentially around the lid proximate to a perimeter of the lid, such that the gasket is selectively insertable into the channel for sealably attaching the lid to the container.

4. The painting supplies storage device of claim 1, wherein the shell is substantially cuboid.

5. The painting supplies storage device of claim 1, further including a handle pivotally attached to the container or to both of the container and the shell, wherein the handle is configured for grasping in a hand of a user, positioning the user for lifting the container and the shell.

6. The painting supplies storage device of claim 1, wherein the rotator assembly comprises:
a second rod pivotally attached to the upper end of the first rod, such that the second rod is selectively pivotable between a stowed configuration, wherein the second rod is substantially parallel with the lid, and a deployed configuration, wherein the second rod extends substantially linearly from the first rod; and
a third rod attached to the second rod distally from the first rod, the third rod extending substantially perpendicularly from the second rod, wherein the third rod is configured for grasping in a hand of a user, positioning the user for rotating the paddles for mixing the paint.

7. The painting supplies storage device of claim 6, wherein the third rod is pivotally attached to the second rod, such that the third rod is selectively pivotable between a stowed position, wherein the third rod is substantially parallel with the second rod, and a deployed position, wherein the third rod extends substantially perpendicularly from the second rod.

8. The painting supplies storage device of claim 7, wherein the third rod is removably and pivotally attachable to the second rod.

9. The painting supplies storage device of claim 1, wherein the rotator assembly comprises:
a second rod pivotally attached to the upper end of the first rod, such that the second rod is selectively pivotable between a stowed configuration, wherein the second rod is substantially parallel with the lid, and a deployed configuration, wherein the second rod extends substantially linearly from the first rod; and
a rotary tool having a drive shaft configured for selectively engaging the second rod distal from the first rod, wherein the rotary tool is configured for selective actuation for rotating the paddles for mixing the paint.

10. The painting supplies storage device of claim 9, wherein the rotary tool comprises:
a housing defining an interior space;
a battery attached to the housing and positioned in the interior space;
a motor attached to the housing and positioned in the interior space, the drive shaft of the motor extending from the housing;
a coupler attached to the drive shaft distal from the housing and being configured for selectively engaging the second rod;
a switch attached to the housing; and
a microprocessor attached to the housing and positioned in the interior space, the microprocessor being operationally engaged to the battery, the motor, and the switch, wherein the switch is configured for being selectively switched for signaling the microprocessor for actuating the motor for mixing the paint.

11. The painting supplies storage device of claim 10, further including a timer operationally engaged to the microprocessor, such that the timer enables a mixing schedule.

12. The painting supplies storage device of claim 10, further including:
the battery being rechargeable; and
a port operationally engaged to the microprocessor, wherein the port is configured for selectively coupling to a plug of a charging cord for charging the battery.

13. The painting supplies storage device of claim 10, further including:
the battery being rechargeable; and
a solar panel operationally engaged to the microprocessor, wherein the solar panel is configured for converting electromagnetic radiation to an electrical current for charging the battery.

14. The painting supplies storage device of claim 10, further including an arm attached to and extending from a lower facet of the housing distal from the drive shaft, the arm being substantially parallel to the drive shaft, such that the arm is selectively insertable into the shell as the rotary tool is attached to the second rod, positioning the arm for preventing rotation of the rotary tool relative to the container as the paint is being mixed.

15. The painting supplies storage device of claim 1, further including:
a pleated tube having a lower limit attached to the lid and extending circumferentially around the hole, the pleated tube being elastomeric and conically frustum shaped;
an O-ring attached to the pleated tube proximate to an upper limit of the pleated tube; and
a collar positioned around the pleated tube proximate to the upper limit, such that the O-ring is compressed between the collar and the first rod, wherein the pleated tube and the O-ring are configured for preventing passage of gas through the hole.

16. A painting supplies storage device comprising:
a container having an open top, wherein the container is configured for addition of an open can of paint through the open top, the container being cylindrical;
a rim attached to the container and extending circumferentially around the open top;
a channel extending into and circumferentially around the rim;
a lid selectively attachable to the container for sealably closing the open top;
a gasket attached to the lid and extending circumferentially around the lid proximate to a perimeter of the lid, such that the gasket is selectively insertable into the channel for sealably attaching the lid to the container;
a hole axially positioned in the lid;
a first rod positioned through the hole such that a lower end of the first rod is positioned proximate to a bottom of the container and an upper end of the first rod protrudes from the lid, the first rod being rotationally and sealably attached to the lid;
a pleated tube having a lower limit attached to the lid and extending circumferentially around the hole, the pleated tube being elastomeric and conically frustum shaped;
an O-ring attached to the pleated tube proximate to an upper limit of the pleated tube;
a collar positioned around the pleated tube proximate to the upper limit, such that the O-ring is compressed between the collar and the first rod, wherein the pleated tube and the O-ring are configured for preventing passage of gas through the hole;
a plurality of paddles attached to and extending from the first rod;
a shell attached to the container and extending from proximate to the bottom to proximate to the open top of the container, an upper facet of the shell being open, wherein the shell is configured for stowage of one or more painting tools, the shell being substantially cuboid;
a rotator assembly attached to the upper end of the first rod and being configured for selectively rotating the first rod, wherein the paddles are configured for mixing the paint, the rotator assembly comprising:
a second rod pivotally attached to the upper end of the first rod, such that the second rod is selectively pivotable between a stowed configuration, wherein the second rod is substantially parallel with the lid, and a deployed configuration, wherein the second rod extends substantially linearly from the first rod, and one or both of:
a third rod removably and pivotally attachable to the second rod distally from the first rod, such that the third rod is selectively pivotable between a stowed position, wherein the third rod is substantially parallel with the second rod, and a deployed position, wherein the third rod extends substantially perpendicularly from the second rod, wherein the third rod is configured for grasping in a hand of a user, positioning the user for rotating the paddles for mixing the paint, and
a rotary tool having a drive shaft configured for selectively engaging the second rod distal from the first rod, wherein the rotary tool is configured for selective actuation for rotating the paddles for mixing the paint, the rotary tool comprising:
a housing defining an interior space,
a battery attached to the housing and positioned in the interior space, the battery being rechargeable,
a motor attached to the housing and positioned in the interior space, the drive shaft of the motor extending from the housing,
a coupler attached to the drive shaft distal from the housing and being configured for selectively engaging the second rod,
a switch attached to the housing,
a microprocessor attached to the housing and positioned in the interior space, the microprocessor being operationally engaged to the battery, the motor, and the switch, wherein the switch is configured for being selectively switched for signaling the microprocessor for actuating the motor for mixing the paint,
a timer operationally engaged to the microprocessor, such that the timer enables a mixing schedule,
a port operationally engaged to the microprocessor, wherein the port is configured for selectively coupling to a plug of a charging cord for charging the battery, and
a solar panel operationally engaged to the microprocessor, wherein the solar panel is configured for converting electromagnetic radiation to an electrical current for charging the battery;
a handle pivotally attached to the container or to both of the container and the shell, wherein the handle is configured for grasping in a hand of a user, positioning the user for lifting the container and the shell; and
an arm attached to and extending from a lower facet of the housing distal from the drive shaft, the arm being substantially parallel to the drive shaft, such that the arm is selectively insertable into the shell as the rotary tool is attached to the second rod, positioning the arm for preventing rotation of the rotary tool relative to the container as the paint is being mixed.

17. A method of storing painting supplies comprising the steps of:
providing an open can of paint and one or more painting tools;
providing a painting supplies storage device comprising:
a container having an open top, wherein the container is configured for addition of the open can of paint through the open top,
a lid selectively attachable to the container for sealably closing the open top,
a hole axially positioned in the lid,
a first rod positioned through the hole such that a lower end of the first rod is positioned proximate to a bottom of the container and an upper end of the first rod protrudes from the lid, the first rod being rotationally and sealably attached to the lid,
a plurality of paddles attached to and extending from the first rod,
a rotator assembly attached to the upper end of the first rod and being configured for selectively rotating the first rod, wherein the paddles are configured for mixing the paint, and
a shell attached to the container and extending from proximate to the bottom to proximate to the open top of the container, an upper facet of the shell being open, wherein the shell is configured for stowage of one or more painting tools;
adding the open can of the paint into the container;
attaching the lid to the container;
inserting the one or more painting tools into the shell; and
selectively rotating the first rod to mix the paint.
